(19) United States
(12) Patent Application Publication
(10) Pub. No.: US 2010/0169092 A1
(43) Pub. Date: Jul. 1, 2010

(54) VOICE INTERFACE OCX

(76) Inventors: Steven J. Backes, Minneapolis, MN (US); Gary D. Manninen, Farmington, MN (US); Clifton R. Farris, Hiwassee, VA (US); Kevin A. Onken, Minneapolis, MN (US); Sharon L. Lensing, Plymouth, MN (US); Scott L. Hudson, Roanoke, VA (US)

Correspondence Address: DARDI & HERBERT, PLLC, 220 S. 6TH ST., SUITE 2000, U.S. BANK PLAZA, MINNEAPOLIS, MN, 55402, US

(21) Appl. No.: 12/626,480

(22) Filed: Nov. 25, 2009

Related U.S. Application Data
(60) Provisional application No. 61/200,270, filed on Nov. 26, 2008.

(51) Int. Cl. G10L 15/26

(52) U.S. Cl. 704/235; 704/E15.045

(57) ABSTRACT

A medical dictation workflow system can be customized from the selection of available user application programs. A voice interface OCX can interface speech technologies with the selected user application programs of the medical dictation workflow system. The medical dictation workflow system may be directed to generating reports through filling out defined fields. The fields can be generated through a tracking system subscribing to a core reporting system and requesting certain information be captured or through a user. The voice interface OCX can provide macros so a user can customize the fields, navigate among the fields, or fill in the fields with data through a voice recognition engine or a wave player control. The data entered into the fields can be automatically entered into corresponding database elements of a database.

### CROSS REFERENCE TO RELATED APPLICATIONS

This application claims priority to copending U.S. Provisional Patent Application, 61/200,270 filed on Nov. 26, 2008 to Faris et al., entitled “Voice Interface OCX,” which is incorporated herein by reference.

### FIELD OF THE INVENTION

The present invention relates to an OCX (OLE Control Extension) for integrating voice technologies into a Windows application, particularly a medical dictation system.

### BACKGROUND OF THE INVENTION

In today's computer industry, software applications exist to service a variety of user needs. Typically medical information systems, for example, are made up of a collection of individual applications that specialize at a particular function while offering limited performance in other functional areas. Given the division of tasks among several applications, integration of the several applications into a single application requires information sharing among the applications. Application integration strategies strive for efficient information sharing to allow a user to work on a single application that calls on individualized applications to perform their specialized functions as needed without explicit knowledge or control of the user.

OCX is an approach to develop custom interfaces so that a single application can use the services of other applications or incorporate objects which contain links to other applications through a nearly transparent interface. OCX is an acronym for OLE Control eXtension and OLE is an acronym for object linking and embedding. OLE is a component software technology provided by Microsoft Corp. that enables a Windows program to add functionality by calling ready-made components while appearing to the end user as just another part of the program.

### SUMMARY OF THE INVENTION

In a first aspect, a method of managing medical information comprises associating database elements of a database interfaced with a medical system for guiding a patient's medical care with discrete document sections of a dictated document. The data is automatically entered into the database elements of the database when data related to medical information is received in the discrete document sections of the dictated document.

In a second aspect, a method of managing medical information comprises receiving dictated text into a marked location within a textual representation of an existing dictation in an audio file based on subsequent dictation into a designated location within the existing dictation in the audio file. The dictated text at the marked location is a textual representation of the subsequent dictation at the designated location.

In a third aspect, a system for managing medical information comprises a server comprising a database interfaced with a medical system for guiding a patient's medical care, wherein the database comprises database sections, and a first computer connected to the server for receiving dictated text into a first document. The first document comprises discrete document sections corresponding with the database sections of the database. The data related to the dictated text received into the discrete document sections is automatically entered into the database sections.

### BRIEF DESCRIPTION OF THE DRAWINGS

FIG. 1 illustrates an embodiment of the system in simplified block diagram form.

FIG. 2 illustrates an embodiment of the system in detailed block diagram form.

FIG. 3 illustrates possible technical configurations of the system over different networks in block diagram form.

FIG. 4 illustrates the functional modules of the Speech OCX.

FIG. 5 is a flow diagram illustrating how the tracking system operates relating to field map set-up.

FIG. 6 illustrates field map transmission in a flow diagram.

FIG. 7 is a flow diagram illustrating the macro set-up relating to the reporting system fields.

FIG. 8 illustrates a flow diagram relating to setting up voice macro fields.

FIG. 9 is a flow diagram illustrating the reporting process.

FIG. 10 is a flow diagram illustrating an alternate method of operation in accordance with an embodiment of the invention.

FIG. 11 depicts another embodiment in accordance with the invention.

FIG. 12 is a flow diagram illustrating yet another method of operation in accordance with an embodiment of the invention.

### DETAILED DESCRIPTION OF THE INVENTION

Objects, as the term is used herein, can include text, charts, graphs, spreadsheet tables, bitmap images, vector drawings, sound bites, video clips, programs, and nearly anything else that can be displayed, controlled, or manipulated by a software application. A container object contains linked or embedded objects that retain connection with the original application that created them through respective linked or embedded connections. In linked connections, actual data associated with the contained object resides in a separate object. In embedded connections, actual data associated with the contained object resides within the container object. In either case, the contained object can only be edited by the application that originally created it.

In some integration strategies, certain data is stored with a linked or embedded object to provide the information necessary for tracking the embedded or linked object back to the originating application. Embedding and linking create immutable “hard” connections between the linked or embedded object and the originating application. To connect a linked/embedded object with an outside application, a pre-defined connection is required.

As described herein, features of a voice interface OCX comprises a complete collection of controls, including component object model (COM) objects, ActiveX/OCX controls, and dynamic link library for integrating voice technologies into a Windows application for a complete medical dictation workflow system. Features of the Atirix™ Voice Interface OCX include the ability to: accommodate multiple voice engines seamlessly through an abstraction layer without affecting the user's work experience; define, edit, and incorporate macros into dictation; navigate and control dictation field using macros; automatically format text; accommodate multiple dictators within the same report/note and allow corrections to voice models; control screen appearance; correct voice models on the server; override and control Windows through voice; accommodate a dictation/edit toolbar dialog window for editing dictated text and controlling dictation; accommodate a speechmike OCX control as an interface for a speechmike unit (such as a Philips SpeechMike); accommodate a speechmike synch controller such that the speechmike unit can be used to navigate among text and macros and control voice; accommodate a text-to-speech (TTS) engine controller for the ability to use different TTS engines; accommodate a sound device manager OCX for keeping events between windows and voice interface in synch; accommodate a voice command controller controlling the functionality of dynamically defined voice command vocabularies; accommodate a contained object controller for keeping up with positions of objects in a dictation; accommodate a number format controller that formats numbers from dictation input; accommodate alternate correction list controller that reformats text based on a user defined list from input from a voice engine; accommodate a word formatter controller that formats text for display in the rich text format (RTF) box; accommodate a text handler controller that overrides Microsoft Windows® control but forces function through Microsoft Windows; accommodate a message router control that handles interactions between components that offer the features of the OCX; accommodate a global information/settings container that holds globally accessible information about the environment and user; accommodate a debug message window for password accessible display of all debug/error messages; accommodate a reporting controller for centralized reporting of error and debug messages; accommodate a foot pedal device controller to navigate and playback notes; allow dictation to be split across multiple table cells; accommodate a wave player control that allows the user to dictate without a voice engine interface.

The voice interface OCX can be suitable for any area of medicine, particularly mammography and radiology, where medical notes and reports are dictated, a report or letter is sent to a referring clinician and a patient, and a tracking system is used to manage patient follow-up and reminders. Other areas include cardiology, orthopedics, oncology, physical therapy, neurology, gastroenterology, hematology, pathology, ophthalmology, dentistry, related surgical or diagnostic specialties, and general medicine.

The general implementation of integration of dictation functionality with medical records software is described in U.S. Pat. No. 6,834,264 to Lucas et al., entitled “Method and Apparatus for Voice Dictation and Document Production,” which is incorporated herein by reference. In addition to other applications noted above, the Voice Interface OCX can be integrated with a mammography records management system such as the system described in published U.S. patent application 2006/0212317A to Hahn et al., entitled “Mammography Operational Management System and Method,” incorporated herein by reference.

As described herein, the OCX comprises features of user application programs that may be executed by a computer system to obtain a medical dictation workflow system. The computer system can be a personal computer, workstation, or a handheld computing device that includes a processing unit which operates according to instructions stored in its memory. Input/output (I/O) circuits interface the central processing unit with one or more input devices and output devices. The input device may be any device for inputting commands to a computer, which can include one or more of any of the following: keyboard, keypad, infra red transmitter, microphone, voice detector, pointing device, light pen, mouse, touch screen, or stylus. The output device may comprise, for example, a display, such as a monitor, a speechmike, a speaker, a printer or other peripheral devices connected through I/O ports contained within the I/O circuits. The computer system may also include a storage device, such as a hard disk drive, a floppy disk drive, a PCMCIA flash drive, or an optical disk drive.

The computer system operates in accordance with programs stored in its memory. The programs running on the computer system may be generally characterized as either operating system programs or user application programs. The operating system programs are a set of programs to control and coordinate the operation of hardware and software in a computer system. The operating system programs direct the execution of user application programs, supervise the location, storage, and retrieval of data, and allocate resources of the computer system to the various tasks to be performed. User application programs, also known as user applications or simply applications, on the other hand, are programs which are used to perform tasks at the direction of users. Examples of user applications include word processing programs, database programs, spreadsheet programs, and personal information managers. Examples of medical applications include VoxReports™, a speech-driven workflow system for medical reporting from Atirix Medical Systems, Inc. Generally, the programs described herein operate in a Microsoft Windows operating system environment, including Windows XP, Windows Vista, and Windows 7, although the programs can be implemented in other operating system environments as well.

In embodiments of particular interest, the OCX provides improved functionality that simplifies its use as well as improved interfacing with a medical management program. Through the OCX, different voice technologies can be seamlessly integrated into a medical management program within a Microsoft Windows® operating system environment without requiring explicit knowledge of or control by the user. The OCX allows efficient and user-friendly sharing of information based on voice data received from one or more different voice technologies among different applications that form the medical management program.

### VoxMG-Overall Model

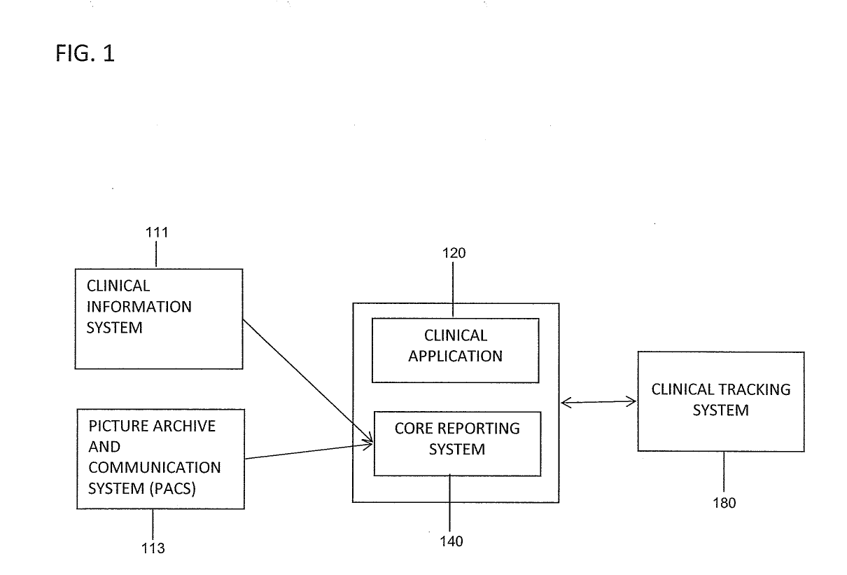

A computer system user can build a customized medical dictation workflow system from a selection of available user application programs provided by any number of software vendors. An example is a product called “VoxMG”, which is an implementation of the VoxReports product for Mammography reporting and tracking. VoxMG is primarily comprised of VoxReports and another Atirix product, MG-Track, which is a web-based product for mammography patient tracking, among other modules. The voice interface OCX can incorporate voice technologies into the system, such that the various application programs can process voice data from the voice technologies. FIG. 1 illustrates an embodiment of the system in simplified block diagram form. While a user is working on generating a report through a clinical application system 120 using a voice technology, such as a voice recognition engine 160 or a wave player control, additional functionality or features can be provided through other systems, such as the core reporting system 140 and clinical tracking system 180. The core reporting system 140 can be interfaced with clinical information systems 111, such as HIS and RIS, and technology systems, such as PACS 113.

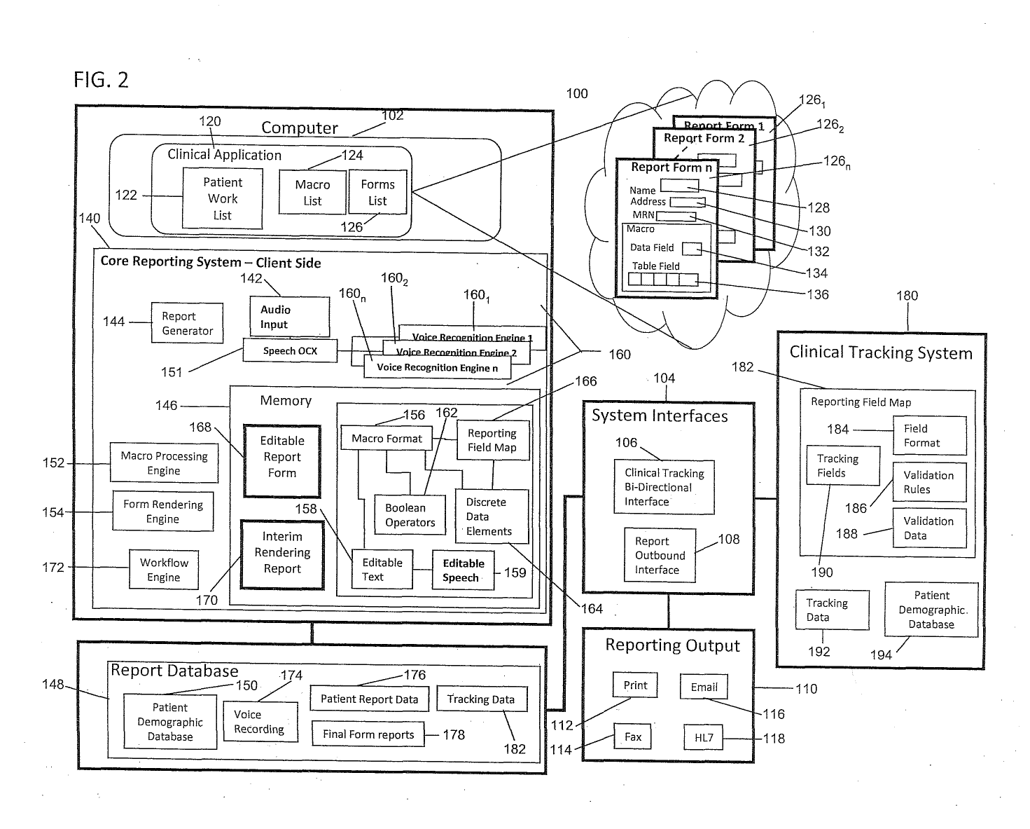

FIG. 2 illustrates an embodiment of the system in detailed block diagram form. Generally, the user invokes the clinical application program 120, which interfaces with the voice technology, such as voice recognition engine 160 or wave player control, and the core reporting system 140 through a nearly transparent interface. The clinical application program 120 provides the user with several tools for generating a report, including selection of one or more forms from a forms list 126, selection of one or more patients from a patient work list 122, and selection of one or more macros from a macro list 124. The selected macro can format a selected form from the forms list 126 or generate form(s) either for the forms list 126 or select appropriate form(s) from the forms list 126. The macro list 124 can also be used to fill in fields in the forms or command certain functions, such as toggling between selected forms or changing screen or window appearance. The selection of patients, macros, and forms can be done verbally through the use of a voice recognition engine 160 or manually through other suitable input means as described above, such as a mouse or keyboard.

The core reporting system 140 is behind the functionality and operation of the clinical application 120. The core reporting system 140 can be provided through software installed by the user as an application resident on the client computer that the user is working on. In another embodiment, a browser can be used to access the core reporting system 140 that is residing on a Web server accessible by a network connection from the client computer. The core reporting system 140 can be observed to be operating on two levels—from the client side and from the server side. The different functions of the core reporting system 140 can reside on the client side on the user computer or on the server that is accessed via browser.

The core reporting system 140 comprises a report generator 144, audio input 142, speech OCX 151, and voice recognition engine 160, the functions of which can be on either the client or server side. The speech OCX interfaces the audio input 142 with the voice recognition engine(s) 160. The speech OCX provides the interfaces for the different possible voice technologies, such as voice engines 160 1, 160 2 . . . 160 n or wave player control, to cooperate with the different applications. Voice data generated through the voice technology can be shared with the core reporting system and other sub-systems that enhance the functionality of the core reporting system 140, such as the clinical tracking system 180. The core reporting system 140 processes data from the voice engine 160 received through its audio input 142 in order to generate a report through its report generator 144. The voice data can be used to perform specific tasks to obtain a final report, such as selection and format of a particular report form, generation of text to fill in the fields of the report, and editing of the text in the form.

The core reporting system 140 can comprise a macro processing engine 152, forms rendering engine 154, workflow engine 172, memory 146, and report database 148, which are illustrated on the server side in FIG. 2. Being on the server side, these modules can be accessed through a browser. Any—whether all, some, or none—of these modules and their functions can reside on the clients side. A voice command to select a macro as interpreted by a voice engine 160 can be received through the audio input 142 and processed by the macro processing engine 152 to determine and put into effect the macro. The form rendering engine 154 works with the macro processing engine 152 to display forms in the forms list 126 or format a form that is selected from the forms list 126. The workflow engine 172 ensures orderly and smooth workflow by keeping track of the form in its various stages of processing, including routing the form to one or more user(s) that may provide edits.

The core reporting system 140 has a memory 146 can contain the selected macro format 156 for the report form, which includes editable text 158 either auto-loaded into the report template or filled into the fields using a voice recognition engine 160 or keyboard and associated editable speech 159, Boolean operators 162 for effecting data into the fields, and discrete data elements 162 that are designated to be extracted from the selected form. The determination of which fields constitute discrete data elements is based on the reporting field map 166 as obtained from the clinical tracking system 180. The memory 146 can also store the editable report form 168 with or without editable text in the fields and the interim rendering report 170 with filled out fields, which are used to generate the final report.

The core reporting system 120 also has a report database 148 that stores information relating to filling out a report. The report database 148 includes several component modules. A patient demographic database 150 contains patient information and provides patients in the patient work list 122. A voice recording module 174 contains voice profiles of users that can be updated. A patient report data module 176 stores report data as supplied by the user through the voice recognition engine 160. A final form reports module 178 can store the report with the data in its final form, such as in Adobe PDF format. A tracking data module 182 can store the data that is extracted from the report.

The clinical tracking system 180 can subscribe to the reporting system and request that certain information be captured, and the core reporting system 140 will publish the information based on this request. Such information related to the generation of a report can be stored in both the clinical tracking system 180 and the core reporting system 140. The clinical tracking system 180 subscribes to specific tracking elements that are captured by extracting data from certain fields of a report or pre-defining fields for capturing the data in a report. The clinical tracking system 180 is equipped with information on what data should be extracted and published, and the core reporting system 180 is involved with executing the data extraction. The clinical tracking system 180 can be specialized for a particular area of medicine, which in turn determines the data that is important in a report for the particular area of medicine. For example, in mammography, the clinical tracking system will be concerned with patient demographic information, BI-RADS scores, lesion charts, and related screening and diagnostic data, including mammography lexicons as defined by the American College of Radiology, as well as related breast imaging lexicons for other diagnostic modalities such as MRI, ultrasound, PET, and tomography. Alternatively, in oncology a LI-RADS score for liver performance, and related liver diagnostic lexicons for MRI, PET, and CT may be of interest. Likewise, in physical therapy and orthopedics, the results of an Oswestry disability survey or other range of motion, functional performance or pain scoring tool may be of interest.

The clinical tracking system 180 has a tracking data module 192 and patient demographic database 194 that corresponds with the tracking data module 182 and patient demographic database 150 of the report database 148 in the core reporting system 180. The corresponding modules of the clinical tracking system 180 and the core reporting system 180 cooperate to track data for extraction or extracted data through the tracking data modules 182, 192 and associate the data with the particular patient through the patient demographic database 150, 194. The clinical tracking system 180 includes a reporting field map 182 that corresponds with the reporting field map 166 of the core reporting system 140. The reporting field map 182 includes modules for field format 184, validation rules 186, validation data 188, and tracking fields that define properties or fields in a report for data capture. The field format module 184 can define fields in a report that data should be extracted from. The validation rules module 186 can provide certain rules for capturing data of certain properties, relating to labels, units, valid values, default values, and required or optional indicators. The validation data module 188 can store data regarding the validation rules, either data to construct or execute the rules or data captured from the report fields based on execution of the rules. Not all fields will be extracted for data. The module for tracking fields 190 will keep track of the fields selected for data extraction.

The clinical tracking system 180 on a server can be interfaced with the core reporting system 140 on a different server via a communications network, such as a public switched telephone network, an intranet, internet, any other communications network, or any combination of data-bearing networks suitable to couple the respective servers to allow communication and data transfer to be performed therebetween. While two servers are shown, the methods and apparatus described herein can be performed equally well by sharing one server, or by sharing two more servers. In some embodiments, system interfaces module 104 can interface the core reporting system 140 with the clinical tracking system 180 through a clinical tracking bi-directional interface 106 that allows data sharing between the core reporting system 140 and clinical tracking system 180 by a self-describing data stream such as in a markup language format (including XML). The self-describing data stream will also include a header with information regarding the reporting and tracking systems. This information in the header is particularly useful in more than one reporting system and/or more than one tracking system is part of the overall system configuration. The system interfaces module 104 can also provide a report outbound interface 108 for interfacing with a reporting output module 110 to deliver a final form of the report through an output means, such as a printer 112, fax 114, e-mail 116, or HL7 118.

### Speech OCX

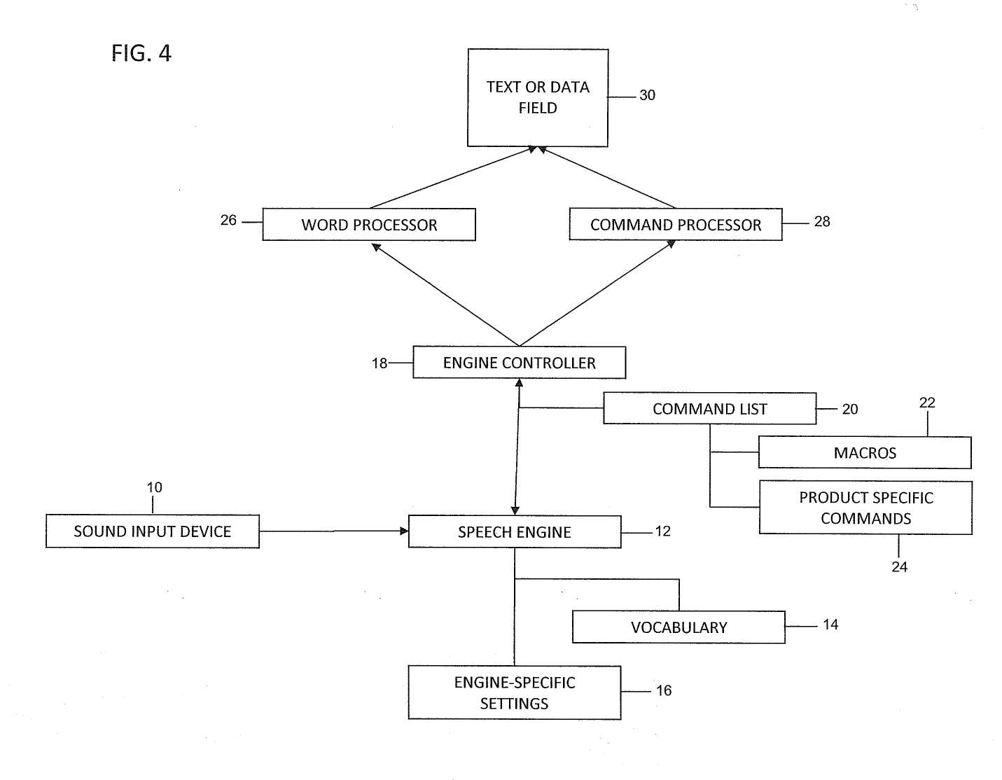

The Speech OCX can ensure that components of the dictation based system can process voice data received from any voice technology. FIG. 4 illustrates the functional modules of the Speech OCX. An input sound can be received through the sound input device 10, which can be any number of different microphones or other devices that input sound into the speech engine 12 for it to interpret. The speech engine 12 can be any number of speech engines, such as IBM's Via Voice or Microsoft's speech engine to name a couple. The engine specific settings 16 can contain configuration settings that are specific to the speech engine that are not user specific. User specific settings will be passed down through the engine controller. The speech engine 12 is backed by vocabulary 14 or base dictionary of words that the voice engine can recognize.

The engine controller 18 determines how to act on the words or commands output by the speech engine 12 and received through the sound input device 10. The engine controller 18 is backed with a command list 20 that includes macros 22 and product specific commands 24. The command list 20 contains a list of commands to be passed to the speech engine 12 to be recognized as commands instead of words if they should appear with the proper pauses around them. The macros 22 contains commands related to macros that when used will place predetermined text into the report in that location. The product specific commands 24 is a list of commands that is either from the OCX itself or can be passed to the OCX from an application that is using the OCX to process sound input as voice recognition.

The engine controller 18 can decide to put the input sound from the sound input device 10 through either a word processor 26 or command processor 28 based on the determination whether the sound is dictated text or a command. The word processor 26 manipulates the inputted words and adds any additional formatting necessary before placing the words into the text or data field for display, which can be passed back to the clinical tracking application 180. The command processor 28 processes the inputted commands. The command processor 28 can use the inputted commands directly to manipulate the word data. If the command was from a parent application, the command can be passed back to the parent application for processing. After being processed by the word processor 26, the formatted words can be saved and displayed in a text or data field 30 in a report or in a database that can be displayed.

### Voice Recognition Engine

The core reporting system may also include a voice recognition engine, such as the runtime portion of ViaVoice™ manufactured by IBM or “Windows Speech Recognition™” from Microsoft. Typically a voice recognition engine is separable into at least two parts: 1) runtime software to perform voice-to-text translation and manage dictated speech in a .WAV file, and 2) administrative software to generate screens and help files and provide the ability to correct translated text. Other voice recognition engines and runtime software may be used without departing from the scope of the invention. An embodiment of the invention may use open-architecture, with respect to the voice recognition engine, so as new voice recognition technologies are developed they can be integrated into the invention.

The voice recognition engine may receive voice input (i.e., dictation) via a coupling to a noise-canceling microphone. Noise-canceling microphones are available in many different styles, such as handheld, tabletop, and headset integrated. The function of a noise-canceling microphone is to help eliminate background noise that may interfere with the accuracy of the voice recognition engine's speech-to-text function (i.e., transcription of spoken words into textual words). The particular noise-canceling microphone used may depend upon the recommendation of the manufacturer of the voice recognition engine. In one embodiment, a model ANC 700 noise-canceling microphone manufactured by Andrea Corporation is used. Some noise-canceling microphones are coupled to the voice recognition engine via a sound card. Still other voice recognition engines may receive voice input from a noise-canceling microphone coupled to a Universal Serial Bus (“USB”) port on the server.

The voice recognition engine may use user voice models, user specific vocabularies, and specialty specific vocabularies to effect the transcription of voice-to-text. The user voice models, user specific vocabularies, and specialty specific vocabularies may be stored in the memory of the second server. Models and vocabularies may be selected based on User ID. User ID may come from the physician dictating speech into the noise-canceling microphone. The physician may enter identification information into the system by means of a computer interface, such as a keyboard or other data entry device before dictating his or her spoken words. Verification of entered data may be accomplished in real time by observation of a computer video monitor/display.

The specialty specific vocabulary may be a database of sounds/words that are specific to a given specialty, such as law or medicine. Using medicine as an example, the single word “endometriosis” may be transcribed as the group of words “end 'o me tree 'o sis” by a voice recognition engine not augmented by a specialty specific vocabulary. Additionally, correction may allow words to be automatically added to a user's vocabulary. The user specific vocabulary may allow users to add words that may not be in a specialty specific vocabulary.

The voice recognition engine, user voice model, user specific vocabularies, specialty specific vocabulary, sound card, and USB port may all be included in a computer workstation of personal computer that is physically separated from, though still in communication with, the core reporting system. Multiple workstations, in a networked computer system, represented by reference numbers, may access the core reporting system. The multiple workstations need not be identical. Alternatively, the voice recognition engine, user voice model, user specific vocabularies, specialty specific vocabulary, macros and templates, sound card, and USB port, represented as being included in workstation, may all be included in the core reporting systems. All voice models may reside in the core reporting system and be moved to each user when the user logs on. The models can be copied back to the core reporting system if, for example, a voice model changes during that session. The output of the voice recognition engine may be applied to a database that stores text files and associated other files related to a dictation session. The format of the database may be, for example, Access™ by Microsoft, SQL Server™ by Microsoft or Microsoft Data Engine (MSDE™) by Microsoft. Other formats may be used without departing from the scope of the invention.

Files may be logically stored in the database based on, for example, whether they are stored awaiting editing or stored for archival purposes. Regarding files stored for editing, at least three types of files may be stored: 1) an audio file that is generated by the voice recognition engine as a user dictates; 2) a corresponding editable text file that was either generated concurrently with the audio file, was generated by running the audio file through a voice recognition engine, or may have been typed in; and 3) a synchronization and indexing file that synchronizes and indexes the sounds in the audio file to the text in the editable text file. The audio file may be in .WAV format, other formats may also be used. The editable text file may remain in an editable format throughout any processing of the files that may be required.

Processing may include any number of cycles of editing, review, and approval. At the conclusion of processing, the data in the editable text file may be stored in a read-only format (referred to hereinafter as read-only text file. Read-only text files are stored without an association to an audio file or a corresponding synchronization and indexing file. In an embodiment of the invention, the audio file, editable text file, and synchronization and indexing file used to prepare the read-only text file are deleted from memory once the read-only text file is approved. One purpose of deleting the files used to prepare the read-only text file is to reduce storage space required in the core reporting system or other data storage device (not shown) used to store such data. Another purpose of deleting the files used to prepare the read-only text file is to prevent tampering or accidental alteration of the stored documents. A read-only text file 354 may be signed and stored as an electronic signature.

The audio file, transcribed dictation file, and indexing file are stored in a memory 146, which may be, for example, a hard disk or some other type of random access memory. The transcribed dictation file may be saved as an editable text file. The audio file and editable transcribed text file may be indexed by the indexing file, such that each transcribed word of dictation in the editable transcribed text file is referenced to a location, and thus a sound, in the associated audio file. Alternatively, the audio file and editable transcribed text file may be indexed by the indexing file, such that each transcribed letter of dictation in the editable transcribed text file is referenced to a location, and thus a sound, in the associated audio file. Indexing, or tagging, each letter in the editable transcribed text file, as opposed to each word, improves playback of the audio file and improves editing capability by providing more granularity to the process.

The process of editing transcribed dictation is improved by enabling an editor to select a questioned word or words (or alternatively letter or letters), from the editable transcribed text file and hear the user's recorded voice associated with that selection. When the text is presented to an editor on a computer screen, the editor can click on the text and hear the user's voice associated with that text. The editor can correct any errors based on the voice recognition engine's 160 interpretation of the voice. The voice model may be updated by editing single words to one or more words or multiple words into a single word. Alternatively, or conjunctively, the model may be updated by editorial manipulation of single letters of text.

Associated with the voice recognition engine 160 is a database of voice profiles for each user. The correction of errors in the interpretation of the user's voice by the voice recognition engine 160 can be synchronized with the user's voice profile, thus updating the user's voice profile. Because the user's voice profile has been updated, probability dictates that the error may not occur again. The process of editing improves the user's voice model.

After the processes of dictation and editing are completed, and the text contained in the editable transcribed text file is approved, the file containing the approved text is saved in a read-only format, (the saved file will hereinafter be referred to as “read-only format file”) thus, effectively deleting the editable transcribed text file from memory. The read-only format file may be signed and stored as an electronic signature. Saving the approved text in a read-only format avoids accidental or deliberate tampering with the approved text.

Furthermore, to save storage space in the memory, the audio file generated in concert with the editable transcribed text file, as well as the associated indexing file, may be deleted from the memory after the editable transcribed text file is approved. Logical storage of the pre-approved editable transcribed text file may be in a first section of memory reserved for editable text, while logical storage of post approved read-only transcribed text file may be in a second section of memory reserved for read-only text. Storage in separate logical memory locations improves the speed for a user to replicate a database at a remote location. The scalability to multiple remote sites may be improved with separate logical storage because a user need only mirror read-only transcribed text files, and may thus avoid the unnecessary copying of large audio files and editable files that may not be required at the remote sites. It will be understood that the editable transcribed text file and the corresponding read-only transcribed text file need not share memory contemporaneously with one another. Additionally, the editable transcribed text file and the read-only transcribed text file may be stored in a common section of memory.

### The Wave Player Control

The “wave” (commonly referring to .WAV sound files) player control allows the user to use straight or normal dictation without a voice engine interface by recording a wave file for regular transcription. Record formats, such as PCM and IBM ADPCM, can be used. IBM ADPCM can be the default format. The wave player control can add or load other formats as needed or desired.

The wave player control allows the user to create and utilize macro abilities within a wave file by creating insertion points in the wave file or selecting parts of the wave file for overwriting. Once a macro is created from a normal dictation, the user will only need to dictate within the dictation insertion points, not wasting time dictating the entire note over and over. The macro created from the normal dictation should be used in concert with a textual representation of the wave version of the macro so the editor can transcribe only the parts that were dictated or changed.

The editor and the dictator have the ability to embed textual notes to one another or for themselves inside the wave file. If the editor selects part of the wave file and adds a mark, they can add text to that mark by right clicking on the mark. The editor can indicate to the dictator (e.g. doctor) that they did not understand the selected part and request that the selected part be re-dictated. The dictator can re-dictate, overwriting the selected part of the wave file. The editor can skip to the selected part and see what was inserted into the wave file or what was changed in the wave file, not wasting time listening to the whole file.

A left click on a mark will display the text associated with the mark, if any, and a double right click on the mark will allow editing of the text for this mark. Each mark can contain a text description or comment. Each view contains its own marks and comments. The current mark view also stays in synch with the current wave file position as it is played, recording, etc. . . . . The current position marker can be adjusted by clicking and dragging it, allowing the user to see upcoming or past marks better. The view of the current position marker can be 50%. The current position marker can be moved in 10% increments or it can be set by the user through the application interface.

The wave player control can comprise several features or functions including a record button; playback button; fast forward button; rewind button; pause button; stop button; insert/overwrite check box; current position time display; end/total time display; sound level meter; current file position slider display; add mark button; remove mark button; next mark button; previous mark button; clear selection button; and list of views drop down, including dictation fields view, dictation comments view, editor comments view, and dictation inserts view.

### VoxMG-Technical Configuration

The system can be implemented through a local area network, wide area network, virtual private network, internet, or a mobile device network if a mobile device is used. A local area network (LAN) is a computer network covering a small physical area, like a home, office, or small group of buildings, such as a school, or an airport. A wide area network (WAN) is a computer network that covers a broad area (i.e., any network whose communications links cross metropolitan, regional, or national boundaries). A virtual private network (VPN) is a computer network that is implemented in an additional software layer (overlay) on top of an existing larger network for the purpose of creating a private scope of computer communications or providing a secure extension of a private network into an insecure network such as the Internet. The Internet is a global system of interconnected computer networks that use the standard Internet Protocol Suite (TCP/IP) to serve billions of users worldwide. Mobile devices can be connected with the system over a mobile device network.

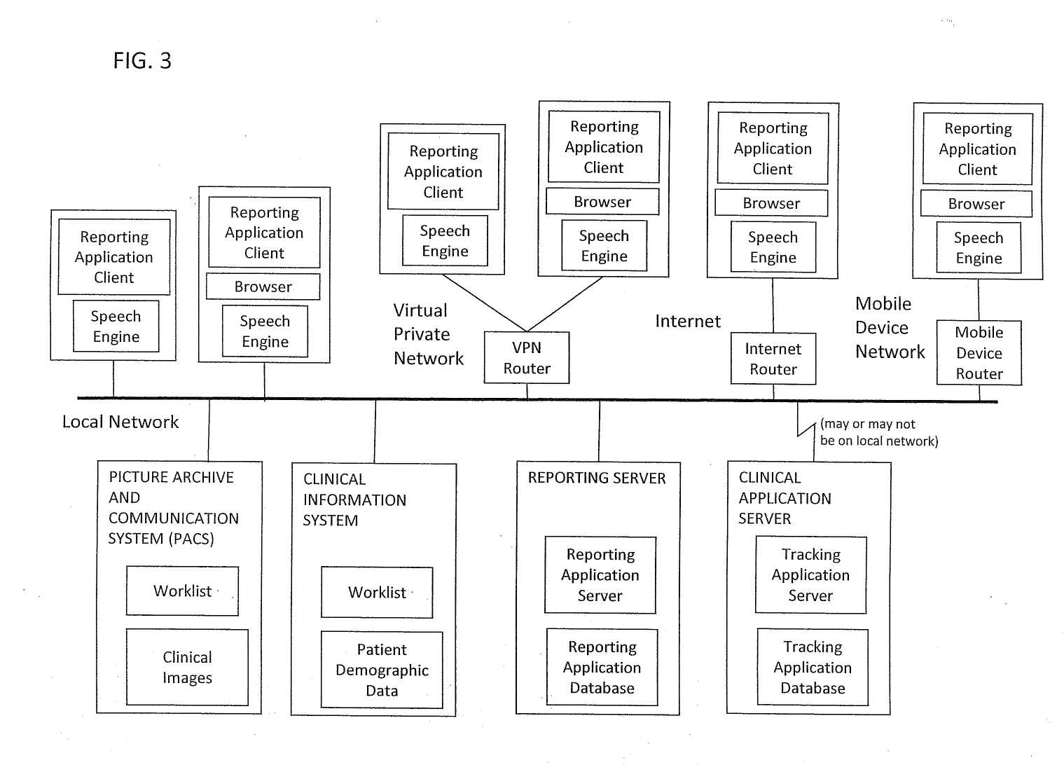

FIG. 3 illustrates possible technical configurations of the system over different networks in block diagram form. A user on a computer or mobile device on a local network, virtual private network, internet, or mobile device network through the clinical application can interact with the servers running the core reporting system and the clinical tracking system. Any of the systems—PACS, clinical information system, core reporting system, and clinical tracking system—can be on a server that is local or remote from the computer with the clinical application program, and a browser can be used to access the system on the server. As shown, each of the computers on the local network, virtual private network, and internet and mobile device on the mobile device network comprise a clinical application (e.g. reporting application client) on which the client works on and a speech engine (e.g. voice recognition engine). They may include a browser to allow access of any number of applications, including PACS, clinical information system, reporting server (e.g. core reporting system), and clinical application server (e.g. clinical tracking system). The VPN, internet, and mobile device networks can also include the VPN router, internet router, and mobile device router.

### VoxMG-Field Map Set-Up-Tracking System

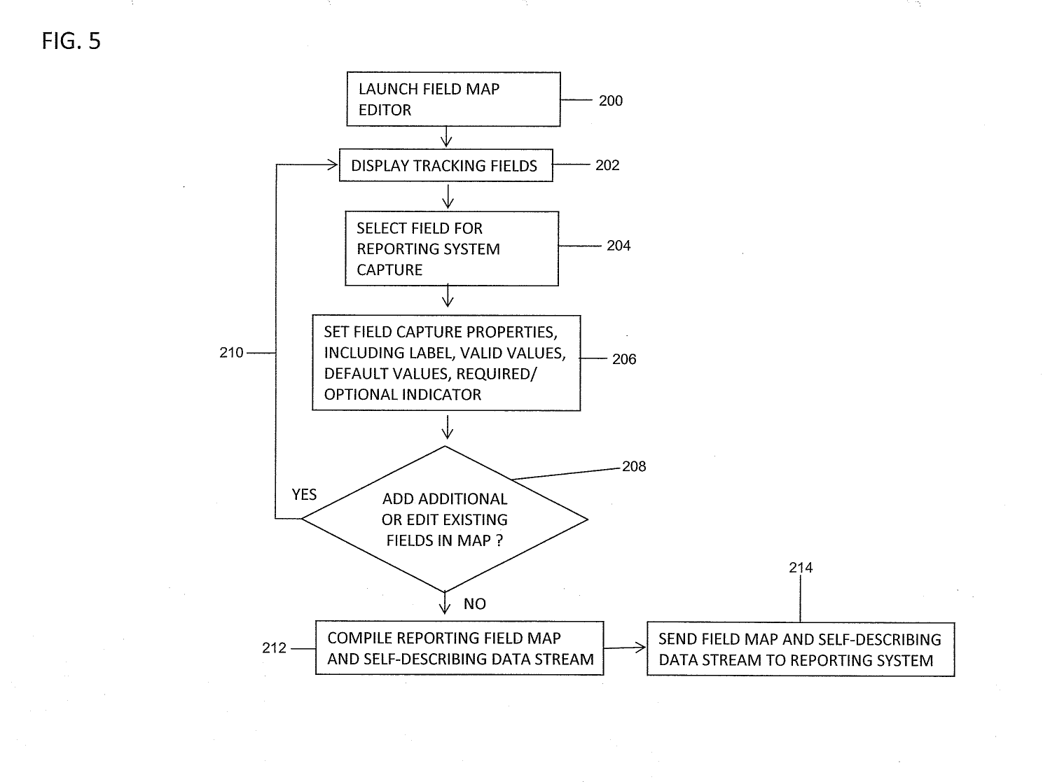

FIG. 5 is a flow diagram illustrating how the clinical tracking system 180 operates. The clinical tracking system 180 provides the rules for determining which fields should be defined or designated for data extraction. The core reporting system 140 implements these rules. The clinical tracking system 180 provides rules based on the area of medicine. In particular, if a mammography report is desired, the clinical tracking system 180 can specify that data regarding lesions in the breast, such as measurements of the lesions, be taken and provide fields, display diagrams such as JPEG, GIF or vector diagrams of standardized quadrant charts, clock diagrams, or other diagnostic representations as an aid to data entry, or request data on such. This is accomplished in several steps that may not be visible to the user based on the nearly transparent interfaces that allow a user to work on the clinical application program 120 that calls on the functionality of other components without requiring explicit knowledge or control of the user.

At step 200, the field map editor or reporting field map 182 is launched. The field map editor contains default information that the clinical tracking system 180 deems important to collect and track. This information may be altered by the user's selection of macro from the macro list 124. At step 202, the tracking fields are displayed. These tracking fields may be the default fields automatically provided by the clinical tracking system 180.

These fields may be altered based on the user's selection of macro from the macro list 124. For example, the macro or function {<<Field NAME> DEFAULT>>}, which is often referred to as a placeholder, allows for field customization. The “field name” and “default” response can be verbally or manually changed to customize fields in a report. For example, the “field name” can be changed to uterus, and the “default” response can be changed to normal. Using database fields in the macros allows information from the database to be pulled into the dictations. The macro list can contain functions that perform analysis based on data provided by the user and/or data from the database. For example, the age of the patient can be calculated based on the date of birth of the patient in the database and the date of the dictation.

All of the fields may be tracked even though data from only some of the fields are extracted. In other cases, only fields from which data extraction occurs will be tracked. At step 204, one or more fields can be selected from which data can be captured by the core reporting system 140. All default fields can be selected for reporting system capture as well as additional fields selected by the user through the macros.

At step 206, the field capture properties are set. These properties include labels, valid values, default values, required indicators, and optional indicators. The clinical tracking system 180 may provide default settings and/or the user may provide settings to the additional fields that were selected at step 204. Particular to breast screening exams, the following business rules govern the entry of the screening results, and may help guide the layout of the report and the capture of related elements:
Breast Parenchyma—The default value for this option is Average. The radiologist can choose the other options depending on the exam results.
Benign Findings—For all options—Calcium, Stable Mass or Implants they can choose whether it is on the left or the right breast or both. If they select Implants option, they can select one or more of the options—Sub Pectoral, Pre Pectoral, Saline and Silicone.
For the results, the options—Negative, no previous exam, Compare, possible abnormality, Compare, essentially normal, Callback, no previous exam, Technical Repeat, Negative, no change from previous exam and Callback, change from previous exam options will be enabled.
If the result Negative, no previous exam or Negative, no change from previous exam is selected and one of the options under Breast Parenchyma is selected, the ACR rating is 1.
If the result Negative, no previous exam or Negative, no change from previous exam is selected and either of Calcium or Stable Mass are selected, the ACR rating is 2.
If the result Callback, no previous exam is selected, the ACR rating is 0a.
If the result Compare, possible abnormality or Compare, essentially normal is selected, the ACR rating is 0b.
If the images obtained are blurry, the radiologist selects the result as Technical Repeat.

Then the user can select one or more of the options—RMLO, LMLO, RCC, and LCC based on which images are not technically good for reading. Once this Option is chosen, the Exam Status is updated as Technical Repeat and a letter is generated and sent to the patient.
The Radiologist can specify if the exam is a priority exam by checking the Priority exam check box.
Even if the patient is below 40 years, if the patient has a family history of cancer, the radiologist can specify that the patient needs to undergo annual mammograms by checking the check box Negative 1 year follow up due to family history.

If Callback or Compare results are selected, the field capture properties include the area of abnormality or area where the lesion is on the breast, type of abnormality, such as calcification, mass, asymmetric density, or architectural distortion, size of abnormality, and recommendations. Again, the report form, including the field map, may include a background diagram as part of the field capture area to help guide the clinician in locating and describing the lesions.

At step 208, the user can add additional fields or edit existing fields in the map. The clinical tracking system 180 may also add additional or edit existing fields in the map based on the macro selected by the user from the macro list 124. If additional fields are added, steps 204 through 206 are repeated 210. If additional fields are not added and fields existing in the map are not edited, then at step 212 the reporting field map along with the corresponding self-describing data stream is compiled into a transmission format such as XML. At step 214, the field map and self-describing data stream is sent to the core reporting system 140 so that data can be collected in the fields and data can be extracted from the designated fields. The sending process may be via a medical industry standard communications mechanism such as HL7, and may involve the use of message queuing services.

### VoxMG-Field Map Transmission

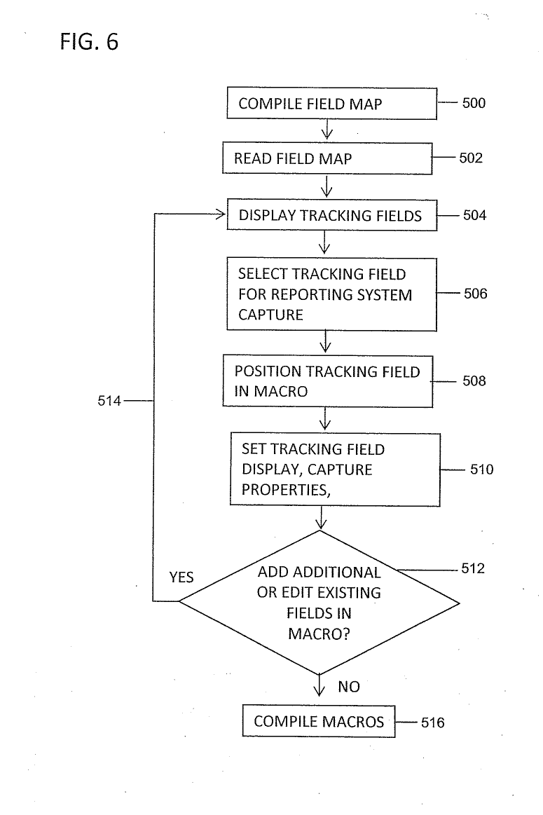

FIG. 6 illustrates field map transmission in a flow diagram. The clinical tracking system 180 can subscribe to the core reporting system 140 and request that certain information be captured. To make the request, the clinical tracking system 180 can compile a field map with tracking fields for the core reporting system 140 at step 500. The core reporting system 140 can read the compiled field map and determine the tracking fields at step 502. Alternatively, the core reporting system 140 can have a default field map that can be customized, such that the request by the clinical tracking system 180 can be used to compile a revised field map at step 500, and the core reporting system 140 can read the revised field map and determine the tracking fields at step 502. At the same time, the client or user can be made aware of the tracking fields through display on the computer at step 504. Not all tracking fields may be subjected to data extraction. At step 506, tracking fields are selected for data extraction. This step can be accomplished by the user or client or further subscription by the clinical tracking system 180 or input by the core reporting system 140.

The tracking fields can be altered customized using macros. At step 508, a tracking field can be positioned in the macro module of the core reporting system 140. At step 510, macros can be used to set tracking field properties, including the display, type of data, etc. For example, macros can be used to define the name of the field and the type of data (e.g. text or number) that the field captures. At step 512, the user or client can add fields or edit existing fields in macro. Macro functions can be used to fill in particular data based on calculation or analysis of data in a pre-existing data. For example, a patient's age in years can be calculated based on the patient's date of birth as contained in a database as of the date of dictation. If the user or client desires additions or edits to the fields at step 514, steps 504 through 512 are repeated until no more additions or edits are made. At this point, macro is compiled at step 516 to generate a report form with customized fields for data.

VoxMG-Macro Set-Up-Reporting System Fields The core reporting system 140 works with the clinical tracking system 180. The core reporting system 140 obtains the data for filling in the fields provided by the field map of the clinical tracking system 180. The core reporting system 140 by receiving a user selection of a macro from a macro list 124 through its macro processing engine 152 can alter the field map provided by the clinical tracking system 180 and stored in the core reporting system 140. The alteration of the field map is optional. If the field map is not altered, the field map can be sent to the macro processing engine 152 for processing, which can determine the macros in the macro list 124 to generate text in the report fields as set by the field map.

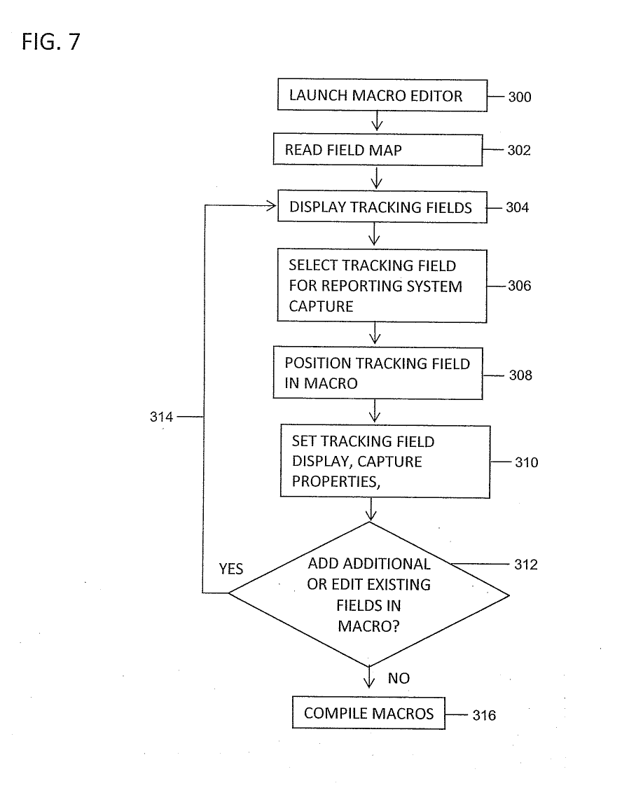

FIG. 7 is a flow diagram illustrating the macro set-up relating to the system fields in the core reporting system 140. Comparing FIG. 5 with FIGS. 6 and 7, it can be seen that many steps parallel with one another. This illustrates the fact that the core reporting system 140 and clinical tracking system 180 cooperate to provide a report with the appropriate fields to be filled in by the user. FIG. 5 focuses on the operation from the perspective of the clinical tracking system 180, FIG. 6 focuses on the transmission of the field map from the clinical tracking system 180 to the core reporting system 140, and FIG. 7 focuses on the operation from the perspective of the core reporting system 140. The clinical tracking system 180 and the core reporting system 140 each can receive updates from the other regarding changes to the field map, changes to tracking fields, and what data is extracted.

At step 300, the macro editor or macro processing engine 152 is launched when a field map is received from the clinical tracking system 180, when the core reporting system 140 indicates that a field map is available, or when the user selects a macro from the macro list 124. At step 302, the field map is read to create a report form with the appropriate fields, appropriate tracking fields, or determine the appropriate tracking fields among a set of fields that will collect data. Data collected in the tracking fields with the stored as discrete data element module 164 in the memory 146, which can be stored in the associated tracking data modules 182, 192 in the core reporting system 140 and clinical tracking system 180. At step 304, these tracking fields can be displayed to the user in the form of a report in the clinical applications program 120 so the user can edit. At step 306, tracking fields are selected for data extraction. At step 308, the tracking field is positioned in the macro. The field map in its various stages, including original field map provided by the clinical tracking system 180 and revised field map, can be the same in both the clinical tracking system 180 and the core reporting system 140. The clinical tracking system 180 and the core reporting system 140 can keep each other abreast of any developments relating to the field map. At step 310, the tracking field display, capture properties, as discussed at step 206, can be set. The tracking fields and what data these fields captured can be compiled for display in a report. At step 312, which corresponds to step 208, there is the option to add additional fields or edit existing fields. If fields are added or edited, then steps 304-312 are repeated, which is denoted as step 314. When additional fields are added or fields are edited, this information can be shared between the core reporting system 140 and the clinical tracking system 180. At step 316, if no fields are added or edited, the macros are compiled and a final reporting field map can be generated to display fields for collecting data. Some or all these fields can be tracked, such that the data can be extracted from these fields and stored in databases in the core reporting system 140 and the clinical tracking system 180. The compiled macros are also registered as commands with the OCX.

Vox MG-Macro-Set-Up-Voice Macro Fields

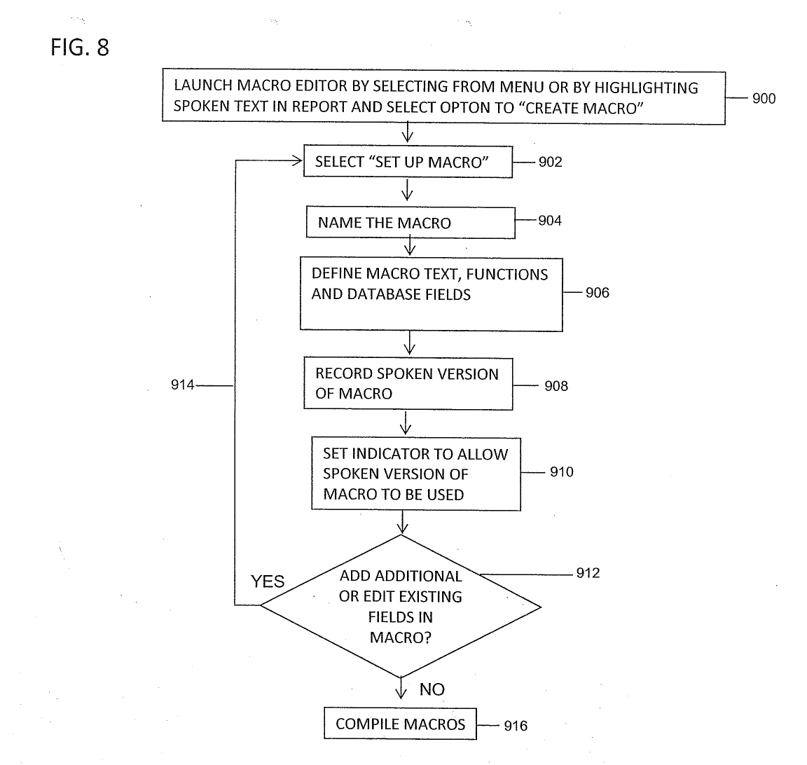

The macros can be used to customize, add, or edit fields in a field map as discussed above. However, the voice macros can be set up to effect voice commands and dictated text using a verbal short cut. The voice macros can be set up to verbally add fields to a field map. FIG. 8 illustrates a flow diagram relating to setting up voice macro fields. At step 900, a user can start up the macro editor through menu selection or highlighting spoken text in a report and selecting the option to “create macro.” At step 902, the user can select “set up macro.” This will allow the user to name the macro at step 904, define macro text, functions, and association with database fields at step 906, record spoken version of macro at step 908, and optionally set an indicator to allow spoken version of macro to be used when desired at step 910. The macro creation process can be used to create or edit fields and/or their contents. Using voice macro, additions or edits to fields can be made in macro. If this is the case, then at step 912, the steps 902-910 repeat for the creation of additional macros including creating or revising fields and/or their contents. If no further changes are desired, the macro is compiled at 916.

### VoxMG-Reporting Process

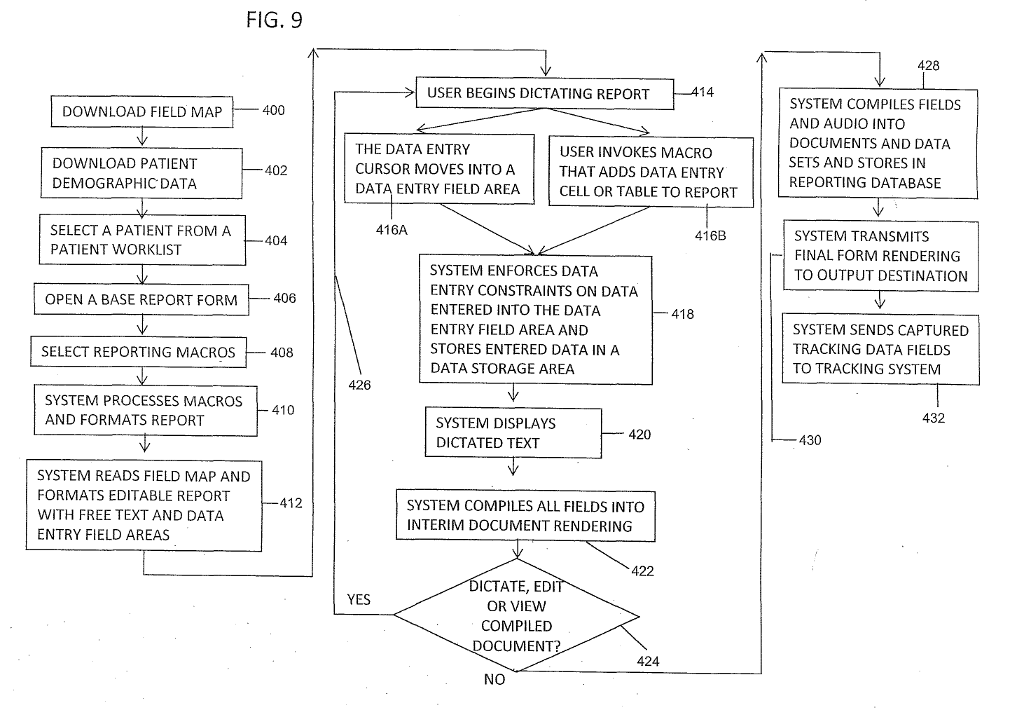

FIG. 9 is a flow diagram illustrating the reporting process using the computer system 102 that comprises a clinical application 110, core reporting system 140, and clinical tracking system 160. The method of operation is illustrated in the context of a medical practice; however, it will be understood by those of skill in the art that the method is equally applicable to other services and industries as well. At step 400, a field map can be downloaded. This can be a base template for a field map provided by the clinical tracking system 180. At step 402, selected data from database holding information relating to patient practice management database is downloaded to a patient demographic database, such that the selected data is available for filling out forms. The clinical tracking system has a patient demographic data module that associates with the patient demographic data module of the core reporting system. Both systems facilitate the association of discrete data elements with specific patients.

At step 404, a first user, i.e., the physician, may select a patient name from the list of patient names previously downloaded. The work list is displayed through the clinical application program. The user may verbally (e.g. voice commands) through a voice recognition engine 160 or, manually (e.g. typing using a keyboard or clicking with a mouse or speechmike pointer) select the identity of an entity (e.g., a patient or client) that will be the subject of a dictation. The entity may be listed on an entity list or patient work list 120 that may be displayed on a computer monitor. The system may also be configured to automatically load the next entity upon completion of the processing (by completing, signing, deferring, cancelling, or saving as draft) the current entity.

The process of generating documents may be improved by giving the user access to legacy information, such as data pertinent to each patient in the patient work list. This data may already be stored in an existing database of the user. For example, a user in the medical profession, such as a physician, may have a practice management system in place to handle the financial, administrative, and clinical needs of his practice. The practice management system may have a wealth of demographic information about each patient seen in the physician's practice. The demographic information may be stored in a database format. Each item of data may therefore be available for use by the core reporting system 140. For example, a physician may have a schedule or roster of patients that will be seen on a given day. Each patient may be listed in the physician's practice management system database.

In accordance with an embodiment of the invention, patient demographic data, for patients to be seen on the given day, may be downloaded from the practice management system database to a patient demographic database before the physician sees the patient. When the physician is ready to prepare notes or complete forms based on the patient's visit on a particular day, the physician may identify the patient to the core reporting system by use of the patient work list. The patient work list is illustrated with M patients, where M is an integer. An embodiment of the invention may accommodate any number of patients; however, it is noted that the number of patients represented in the database need not be equal to the number of patients listed on the patient work list. As the patients are selected from the patient work list, they may be removed from the list to show that the entity has been addressed. This gives a visual reference to the user as to what work has and has not been completed. For example, if a patient's name is selected from the patient work list, the name is removed from the patient work list after the physician dictates his notes. This indicates to the physician that he has dictated a note for that particular visit of that patient. If at the end of the day the physician has an empty patient work list, then he may understand that he has completed all required dictation. If there are names left on the patient work list, then the physician may understand that he may be required to complete further dictation.

At step 406, a base report form is opened. The first user may select the form or forms that will be filled-in during a dictation session. The base report form provides fields based on the patient selected. Reports providing different information can be opened based on the status of the patient as determined and provided by the workflow engine, whether the patient has finished an initial screening or a follow-up. The physician may select the form(s) that will be completed from the forms list. The user may also select a type of document or form (hereinafter “forms”) that the user wishes to populate, or fill-in, with text. Selection of forms is not limited to one document; multiple documents can be selected for sequential or simultaneous data entry and processing during one dictation session.

The forms may be listed on a forms list 126 that may be displayed on the computer monitor. The forms list 126 of FIG. 1 is depicted as having n forms 126 1-126 n, where n is any integer. For ease of illustration, an nth form 126 n is partially illustrated. Forms are generally divided into sections or fields 128-136. Each field may have its own unique descriptor to identify the field, for example, a descriptor may be “Name,” “Address,” or any number or letter combination to uniquely identify the field. It will be understood that there is no limit to the number of fields that can be associated with any of the forms in the forms list 126 and that the representation of fields having reference numbers 128-136 is for illustration purposes only. In accordance with one embodiment of the invention, a user may verbally or manually select a first field, for example the Data Field 134, which the user wishes to fill-in. After the selected field is filled-in, the user may verbally or manually (e.g., with a pointing device or keyboard) command the system to go to another field in the same document or in one of the other previously selected documents.

The forms used can be unique to the user's own practice or industry. The system dynamically generates forms by compiling separate fields of data. The user can also dynamically call in a macro during the course of dictation that contains a field for capturing tracking data, via a voice command or by keyboard or mouse entry. The user populates each of these fields with text as the user dictates into the system. Fields can also be populated by omission with preformatted form defaults. Thus forms, whether new or old, can be compiled by inserting the proper field contents within a text box, check box, or other data entry location in the form.

The use of fields provides a benefit for data-mining of the fields. Data-mining, as used herein, relates to the process of searching a database, or other storage place of data, for particular data or sets of data. The use of separate fields is a benefit because known existing databases for use in dictation generally have data entered in a free-form style. By free-form, it is meant that text is dictated in a fee flow format into essentially one data field, as contrasted with text dictation into structured and distinct fields. Free-form dictation results in data storage that is not amenable to document generation or data-mining Forms customization allows discrete data to be captured and saved.

At step 408, the reporting macro is selected. The macros can determine the type of report. The macros can be directed to the type of medicine, such as mammography, or type of report based on patient status in the workflow engine. At step 410, the clinical tracking system 180 and the core reporting system 140 processes the macros and format the report. For example, if the selected macro is based on the discovery of a lesion near the breast during a preliminary screening, the macros can provide a table displaying fields for entering data on the lesion. At step 412, the core reporting system reads the field map and formats editable report with free text and data entry field areas. The field map can be altered by editing existing fields or adding fields.

At step 414, a user can dictate the report if the field map is finalized for reporting data. The core reporting system may automatically fill-in fields for which data is available, from the database or data added directly into the patient demographic database. Downloaded information may include patient name, address, telephone number, insurance company, known allergies, etc., but, of course, is not limited to these items. An embodiment of the invention may dynamically generate and distribute forms, reports, chart notes, or the like based on the entered dictation. Such documents may be placed in electronic archival storage within the user's own control and additionally the core reporting system may automatically send copies of these documents to third parties. As used herein, the term “documents” includes both electronic and hard copies. Using the medical practice as an example, a physician may dictate chart notes (i.e., a summary of the results of a patient visit) into the core reporting system via the computer. Because dictated information is entered into predefined fields, the core reporting system may integrate the dictated information into an electronic medical chart that can be archived, retrieved, and searched. Forms, reports, charts, or the like can be sent to third parties via any communication channels, such as fax, print, e-mail, and HL7.

When the first user begins dictation at step 414, the data entry cursor can move into a data entry field area at step 416A. Through voice commands, pointing device, or other suitable device, the user can place the data entry cursor into any selected field to fill in data. In an embodiment of the invention, the first user can use macro voice navigation and control to navigate among fields. If the user wishes to create a cell for data entry, the user can invoke macro that adds data entry cell or table to the report at step 416B, and the data entry cursor be positioned into the data entry field or cell at step 416A.

Macro can be used with any of a number of different fields, including linked fields, tables, discrete fields, and list fields. Linked fields are not directly manipulated by the user and receive text from a parent field, being mainly used for text or value replication through the note. Tables comprise cells that can be dealt with by macros as fields. Discrete fields are fields that are tied to fields in a database, such that the text within the fields is directly injected through default text inside the database. When the note/section/report is saved, the field text is saved back to that database field. List fields can pop up a list of voice commands associated with text values that will be placed in the field. The voice commands will be able to reference other macros.

To fill-in a field, the user may dictate speech into an audio input 142 of the computer 102. The audio input device may be a microphone. In an embodiment, the core reporting system 140 can may automatically generate an audio file, an along with an associated transcribed dictation file, and/or an indexing file. Such generation may be accomplished with the use of a voice technology, such as a voice recognition engine 160 or a wave player control.

Data entry includes all fowls of spoken word, including numbers. Any type of data entry may be accommodated, for example, both text boxes and check boxes may be used. Text may be entered into a text box and checkboxes may be checked or unchecked by voice entry. Pointing devices need not be used. Thus, if there are four fields the first user can say “field one” and the text will be entered into field one. The first user can then say “next section” or call the next section by name, such as “field two.” Of course, fields can be named with common names such as “subjective” or “allergies,” and need not be numbered.

As the user dictates speech, the user may wish to perform a verbal abbreviation for certain words, phrases, sentences or entire paragraphs of text that are often repetitive in the course of the user's generation of documents. To allow such abbreviation, the system may allow the user to recite a sound known by the system to represent a certain string of text. Such an abbreviated dictation tool is known as a “macro.” In the medical industry, for example, frequently used phrases are called “norms” or normals, and can be completed by the use of a macro. Macro can provide a field with the ability to do custom log, such as calculation, text manipulation in the field and other fields.

When the system encounters a macro, it substitutes the string of text corresponding to the macro into the text file that is generated by the voice recognition engine. The method of inserting a macro into a string of words in a text file may include: correlating the string of words against entries in a database of command strings; copying, upon identity of correlation, the macro at a pointer address of the command string; and replacing the correlated string of words with the copied macro. The user may indicate to the system that the user's next word will be a macro. In an embodiment of the invention, the user may indicate that the next word is a macro by saying the word “sub” followed by the name of the macro. Thus, a physician may say “sub thanks” and the system may generate the following: “Thank you for referring the above-identified patient to our offices.” The use of norms in the medical services field is well known; however, an embodiment of the invention allows for the use of what are referred to by the inventors as “variable macros” and “prompted macros.”

A variable macro combines a macro with a data variable retrieved from a database. Thus, a user may say “sub thanks” and the system may generate the following: “Thank you for referring [PATIENT NAME] to our offices.” Where [PATIENT NAME] is a data field and the instance of [PATIENT NAME] to be substituted in the example above would be defined by the selection of an entity from the entity list at the beginning of the dictation session. Thus, if the entity were named “John Brown” the actual text generated by the system would be: “Thank you for referring John Brown to our offices.”

A prompted macro allows a user to generate text that requires the insertion of variables that may not be present in the patient demographic database. In an embodiment, the prompted macro is used as follows. The physician says “sub macro_name,” waits for a prompt from the system such as a beep, and then says or enters the variable data. Thus, as an example, if a patient had taken a lead blood level test and the result of 5 deciliters/liter was returned to the physician, the physician may say “sub high lead,” wait for a beep, and then say “five.” The system in turn may generate the following text: “The results of your lead blood screening indicate a level of 5 deciliters/liter. This level is higher than would normally be expected.” Thus, the variable “5” was inserted into an appropriate spot in the text of the macro.

Additionally, after the user indicates to the system that dictation is about to begin, the system provides a visual and/or audible cue to the user to allow the user to understand that the system is ready to accept dictation. In one embodiment, the background of a dictation screen on the computer monitor turns yellow so that the user can easily tell if the voice recognition engine is engaged. When the command “stop dictation” is issued, the background of the dictation screen returns to its original, pre-dictation, color. This also enables the user to see what state the system is in, even if the user is standing or pacing while dictating several feet away from the workstation. In addition to the screen changing color when dictation is initialized and terminated, one embodiment emits an audible tone so that the user does not have to look at the computer screen during dictation. The combination of yellow screen and audible tone makes it clear to the user when the voice recognition engine is starting and stopping, thus avoiding any unnecessary repetition of dictation. Each of these features can be disengaged if not desired by the user.

The system may also fill-in various fields in any of the forms selected by the first user. Data used by the system to fill-in the forms may come from the patient demographic database, which was populated with data downloaded from the first user's own database or from other sources. Because forms are divided into fields, the text in like fields may be shared between different forms and generation of multiple forms may occur contemporaneously. This is an improvement over existing systems, which require a user to fill-in one form at a time. The completion of one form at a time may be driven from a system requirement to engage a voice recognition engine to complete one form and then disengage the voice recognition engine before moving onto the next form. Completion of the dictation session is slowed in that instance, because the user may be duplicating his efforts by filling-in like fields in different forms. In an embodiment of the invention, several forms may be generated in one session, without the need to dictate entries for one form, close that form, and then dictate entries for another form. Once all desired forms are identified, the user can populate the fields of each of the forms in one session.

If the first user's dictation is applied to a voice recognition engine, the output of the voice recognition engine populates fields with like-names in different documents. There is no need to disengage the voice recognition engine in order to dictate a second form. For example, a patient may come to a physician's office for an examination. The physician may use an embodiment of the present invention to document the encounter. The physician may choose a familiar form in which to enter data and can dictate data directly into that form. The physician may also need to generate a request for laboratory work to be performed at a testing laboratory, a follow-up note to the patient, and a thank you letter to the referring physician. Each of these multiple documents may have some fields that are identical to the fields used to record the encounter with the patient, for example “name” and “address.” In accordance with an embodiment of the invention, the system can populate the multiple documents at substantially the same time that the system populates the first document chosen by the physician.

At step 418, as the user dictates information into a field, the system enforces data entry constrains on data entered into the data entry field area and stores entered data into a data storage area, such as a database in the core reporting system 140 and the clinical tracking system 180. For example, the data entry field may be configured for a number, such as for the size of a lesion, and the system ensures that a number is dictated into the field.

At step 420, the system displays the dictated text so the user is able to see it on a display, such as a computer monitor. When the user indicates that dictation is complete, for example, filling in all the fields, the system compiles all fields into an interim document rendering at step 422. This document can be dictated into. The compiled fields and audio may be stored in memory. Existing information in the fields can be edited, or additional information can be added in the interim document. At step 424, the user can view the compiled document, deciding whether to alter the dictated information by editing or adding new information.

If further dictation, editing, or viewing is required, the first user may return to step 414, which is denoted as step 426. The first user or a second user may edit the document.

Authorization of the second user may be required. The second user may edit from any workstation or other input/output device associated with system. Additionally, any editing that the second user performs may update the first user's voice model. This may be important in improving accuracy. Any person with authorization may view the documents on a workstation in communication with the processing and storage system.

If further dictation, editing, or viewing of compiled documents is not desired, then further processing of the documents may occur, for example, at steps 428-432. Further processing may include, but is not limited to: secure storage of transcribed text files in a read-only format; creation of electronic medical records (“EMRs”) or charts that logically combine information for a patient; creation of voice enabled EMRs; display of documents on a monitor; faxing; printing; or e-mailing documents using pre-defined settings. Automated transmission of any document to a pre-defined recipient is accommodated in one embodiment in accordance with the invention. Each created document may be appended to its corresponding patient's electronic patient chart, eliminating any need for cutting and pasting found in some other applications. A search function allows users to retrieve documents using a variety of search options such as keyword, date, patient name, or document type.

Once the dictation session is complete with no further alterations to the dictated information, the system compiles the fields and audio into the selected form(s) and data sets, for example, discrete data elements, and stores it in its reporting database at step 428. Because transcribed information is stored in fields in the reporting database, rather than the actual assembled documents, a user may create numerous documents by assembling or merging the appropriate fields into a faun represented by a document listed on the forms list.

The assembled fields may then be presented as a completed document. At step 430, the system transmit's the report in its final form to an output destination, such as a printer, e-mail, fax, or HL7. At step 432, the core reporting system 140 sends captured tracking data fields to the clinical tracking system 180.

### Alternate Reporting Process

One method for transferring data is a timed script. Other methods include a real-time pull of data from a database and pull of data on demand from a database. In a pull on demand, the system may retrieve information related just to one dictation subject (i.e., one entity) or many dictation subjects. A timed script can acquire the identities of patients to be seen by a physician on a given day. The timed script can download data from a patient database to a temporary directory. The timed script can generate a transferable file using data downloaded to the temporary directory. The timed script downloads the transferable file to the core reporting system. The patient demographic database is populated with data mapped from the transferable file.

A user (e.g., a physician) accesses the clinical application. As part of the access procedure, the physician may indicate his or her identity (e.g., User ID 322) to the application, so that the application is able to associate the physician's User ID with the physician's voice model (e.g., a voice model stored in user voice model file). As part of the access procedure, the physician may also indicate a patient ID (e.g., Patient ID 324), so that the application will be able to associate the patient's ID with patient data downloaded from the clinical tracking system in the transferable file. As part of the access procedure, the physician may also indicate which form types the physician will be using to structure his dictation. Form types may be stored in the memory of the core reporting system.

Access to the application and indication User ID and Patient ID may be made by voice using a noise-cancellation microphone or manual manipulation of a computer interface. Verification of entries is accomplished in real time by observation of a computer video monitor/display. The physician may dictate a report to the application by speaking into the noise-cancellation microphone. The report may be structured in accordance with the form the physician has selected for initial data input. By structure, it is meant that the report may be broken down into a plurality of fields, each field having associated therewith a filed name.

The first user indicates to the application into which field the user will enter dictation. Dictation (i.e., speech) received by the noise-cancellation microphone is converted to electrical signals and applied to the voice recognition engine. The voice recognition engine substantially simultaneously generates an audio file corresponding to the dictated speech, transcribes the dictated speech into an editable text file, and generates a synchronization and indexing file. The audio file may be in .WAV format, other formats may also be used. The synchronization and indexing file associates each transcribed word of text in the editable text file with a sound in the audio file.

The physician indicates to the application that entry of dictation in the first field is complete or that the dictation session is at an end. If dictation is not complete or the dictation session is not at an end, the user may continue dictation. The indications may be explicit, as when the user indicates that dictation in the field is complete, or it may be implicit, as when the user indicates that dictation should commence in the next field. Such an implicit indication may be in the form of the utterance of the words “next section.” Additionally, the application may recognize that data input to a field is complete, as in the case of a checkbox field, where once a box is checked or not checked no further data entry is feasible. In any case, once the dictation session is complete, the application stores the audio file, the editable text file, and the synchronization and indexing file in the second server. The editable text file is edited/processed, with or without the use of the audio file and synchronization and indexing file.

Editing/processing may occur immediately or may be deferred. Even if a note is deferred, a user may return to the note and dictate or otherwise add to the deferred file (note.) The content of the editable text file is approved. The editable text file is saved in a read-only format. For ease of description, the editable text file, which has been saved in a read-only format, will hereinafter be referred to a read-only text file. The editable text file, audio file, and synchronization and indexing file that resulted in the generation of the read-only text file are deleted from the second server. Storing the approved dictated form as a read-only text file prevents persons or automated processes from tampering with the file. Furthermore, deleting the editable text file and its associated audio file, and synchronization and indexing file from the system provides additional storage space for new files. The core reporting system may generate output, such as reports, faxes, and/or emails, by compiling fields previously saved as read-only text files.

### Alternative Reporting Process

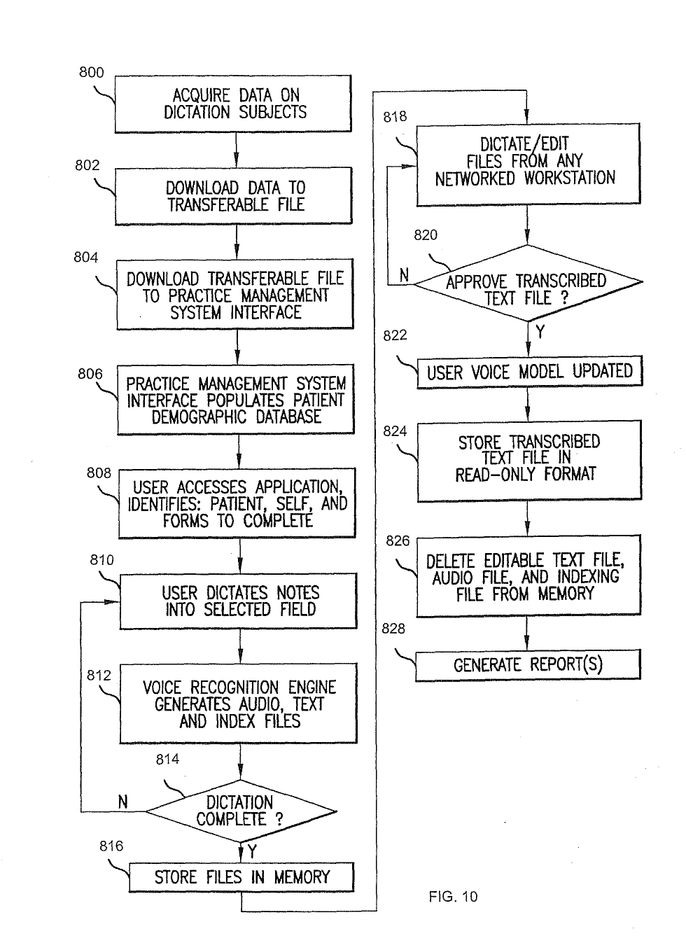

FIG. 10 is a flow diagram illustrating an alternate method of operation in accordance with an embodiment of the invention. At step 800, the system acquires data on dictation subjects from a source, such as, for example, a first server. Data acquisition may be by any manner known to those of ordinary skill. One method of transferring data may be by timed script. Other methods include a real-time transfer of data and a transfer of data on demand. At step 802, acquired data may be downloaded from the source to transferable file. At step 804, the transferable file may be downloaded to a server upon which is located an interface for data processing. At step 806 the interface populates a Dictation Subject Demographic Database with data mapped from the transferable file.

At step 808, a user (e.g., a physician or any network user) accesses the application via a computer interface. The computer interface may be one node in a plurality of nodes of a networked computer system. As part of the access procedure, the physician may indicate his or her identity to the application, so that the application would be able to associate the user's identity with the user's voice model. As part of the access procedure, the user may also indicate a Dictation Subject identity, so that the application would be able to associate the Dictation Subject's identity with the Dictation Subject data downloaded from the source and included in the Dictation Subject Demographic Database. As part of the access procedure, the physician may also indicate which form types the user will be using to structure his dictation. Access to the application and indication User ID and Patient ID may be made by voice using a noise-cancellation microphone or manual manipulation of a computer interface. Verification of entries is accomplished in real time by observation of a computer video monitor or by audible cues provided by the application.

At step 810, the user may dictate notes into selected fields in the form or forms chosen by the user. Each form may be broken down into a plurality of fields, each field having associated therewith a filed name. At step 812, a voice recognition engine receives the dictation and substantially simultaneously generates an audio file corresponding to the dictated speech, transcribes the dictated speech into an editable text file, and generates a synchronization and indexing file. The audio file may be in .WAV format, other formats may also be used. The synchronization and indexing file associates each transcribed word of text in the editable text file with a sound in the audio file. At step 814, if dictation is not complete, the user may add text into selected fields by returning to the step of dictating notes into selected fields, step 810. If, at step 814, the dictation is complete then, at step 816, the application stores the audio file, the editable text file, and the synchronization and indexing file in a memory. The memory may be on a server in the networked computer system. At step 818, the editable text file may be edited/processed, with or without the use of the audio file and synchronization and indexing file.

Editing/processing may occur immediately or may be deferred. Even if a note is deferred, a user may return to the note and dictate or otherwise add to the deferred file (note.) At step 818, the user, or any other authorized user from any computer or workstation in the networked computer system can recall the saved editable text file document or form and add dictation or edit the document or form. In an embodiment, free-foam dictation may be limited to the user, while any other authorized user may be limited to dictating corrections. At step 820, if the editable text file is approved, then at step 822 the user's voice model is updated. At step 824, the editable text file is saved in a read-only format. For ease of description, the editable text file, which has been saved in a read-only format, will hereinafter be referred to a read-only text file. At step 826, the editable text file, audio file, and synchronization and indexing file are deleted from memory. Storing the approved dictated form as a read-only text file prevents persons or automated processes from tampering with the file. Furthermore, deleting the editable text file and its associated audio file, and synchronization and indexing file from the system provides additional storage space for new files. At step 828, the application may generate reports, faxes, and/or emails by compiling fields previously saved as read-only text files.

### Alternate Method of Operation

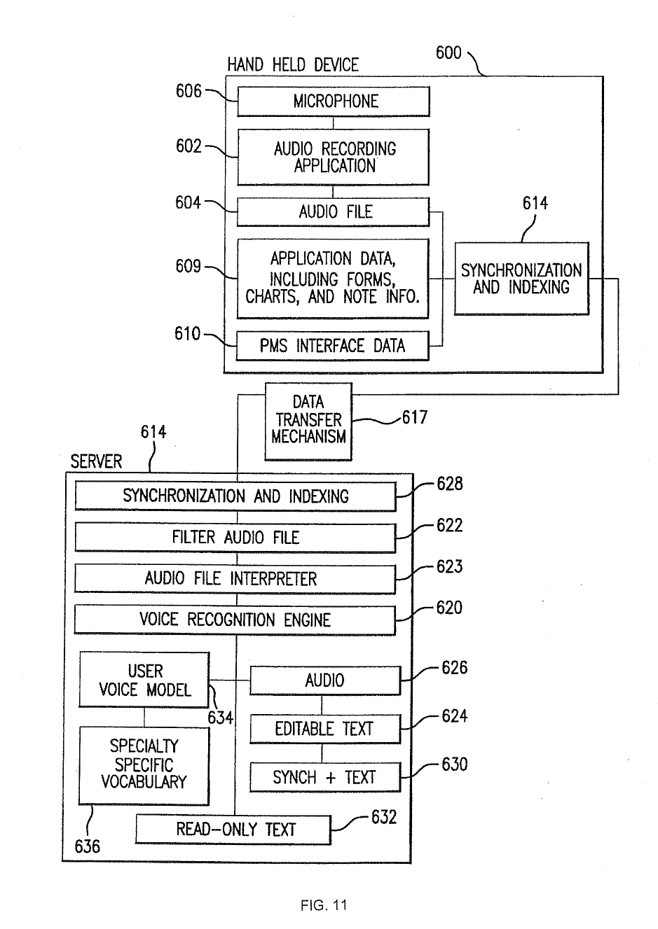

FIG. 11 depicts another embodiment in accordance with the invention. In the embodiment of FIG. 11, a handheld computing device 600, such as a Cassiopeia® by Casio, a Jornada™ by Hewlett-Packard, or an IPAQ™ by Compaq, using a Windows CE™ operating system from Microsoft Corp., may be used to record initial dictation. Other operating systems, such as the Palm™ Operating System by 3COM, Inc. may alternatively be used so long as they support an audio recording capability. In one embodiment, the handheld computing device 600 runs an audio recording application 602 at a sampling rate of 11 kHz that generates a .WAV formatted audio file 604. Of course, other sampling rates and formats of audio files are acceptable without departing from the scope of the invention. The audio file 604 is generated as dictation is entered into the handheld computing device 600. Dictation may be entered into the handheld computing device 600 via a microphone 606 in communication with the handheld computing device 600.

The handheld computing device 600 may acquire data from a server 614 via a data transfer mechanism 617. The data transfer mechanism 617 may include, for example, a modem, a LAN (local area network) interface, an Internet connection, wireless interconnection including radio waves or light waves such as infrared waves, removable data storage device, or hard wired serial or parallel link.

In the exemplary embodiment of FIG. 11, the data transfer mechanism 617 may be a removable data storage device, such as a CompactFlash™ memory card by Pretec Electronics Corp. In one embodiment, the removable data storage device has a storage capacity size of 64 megabytes. The size of removable data storage device is related to the amount of dictation and data a user desires to store on the card; other sizes may be used without departing from the scope of the invention. The removable data storage device may be removed from the handheld computing device 600 and placed into a data storage device reader (not shown) such as the USB CompactFlash™ card reader by Pretec Electronics Corp. The data storage device reader can transfer data from the removable data storage device to the server 614 or can transfer data from the server 614 to the removable data storage device.

In the example of a medical practice, data acquired by the handheld computing device 600 from the server 614 via the data transfer mechanism 617 may include data from a practice management system, which has demographic data on each patient seen in the practice. Patient demographic data and scheduled patient information, for example, may be collected in the same manner as described above. Patient demographic data, perhaps in the form of a transferable file may be input to the handheld computing device 600 and stored in a practice management system interface database 610.

The amount of patient demographic data downloadable to the handheld computing device 600 and the amount of functionality that may be incorporated into the handheld computing device, may be limited by the memory and storage capacity of the handheld computing device 600. As the memory and storage capacity of handheld computing devices increase, the amount of data and functionality incorporated within the handheld device should commensurately increase. Nothing herein should be construed as to limit the types or amounts of data, or to restrict any of the various functionalities of the invention disclosed herein, from being incorporated to the greatest extent possible into a handheld computing device.

Patient demographic data may be used to organize information on the handheld computing device 600. The information downloaded may include demographic data as well as past dictated notes. In addition, the handheld computing device 600 may import application data 609, such as, but not limited to, forms, charts, and note information. The handheld computing device's 600 practice management system interface database 610 may be in the format of Access™ by Microsoft or Sequel Server™ by Sybase. Other database formats are also acceptable and using a different database will not depart from the scope of the invention.

The application data 609 and data stored in the practice management system interface database 610 are synchronized on the handheld computing device 600 by a synchronization and indexing routine 612. The synchronization and indexing routine 612 on the handheld device 600 cooperates with a counterpart synchronization and indexing routine 628 on the server 614. Synchronization in this context refers to downloading of demographic information and application data such as fours, charts, and note information from the server 614 to the handheld computing device 600, and the transfer of audio files and data to the server 614 from the handheld device 600. Once data is downloaded and synchronized on the handheld device 600 the synchronized data is available for document creation and dictation. A dictated audio file 604, will be associated with the form selections made by the user. Other pieces of information, as entered by a stylus, check box, or other method, are also associated with the foam selection. The synchronized audio file 604, application data 609, and data from the practice management system interface database 610 may be prepared for transfer via the data transfer mechanism 617.

Synchronized and indexed data transferred from the handheld device 600 to the server 614 via the data transfer mechanism 617 may require processing before it can be applied to a voice recognition engine 620 included in the server 614. Processing may include filtering to reduce or eliminate background noises present in the audio file 604. Such background noises may have been present during dictation. Processing may also include, but is not limited to, the reduction or elimination of reverb or vibration noises present in the audio file 604. Processing as just described may take place in an audio file filter 622, which may be implemented in software. Processing may also include converting the sampling rate of the audio file 604 from one rate to another. For example, in the embodiment described in FIG. 6, the audio file 604 was recorded using a sampling rate of 11 kHz, however the voice recognition engine 620 requires an audio input having a sampling rate of 22 kHz. Therefore, in the embodiment of FIG. 6, a conversion of sampling rate from 11 kHz to 22 kHz is required. Of course, conversions from one sampling rate to another may not be necessary and conversions from any given sampling rate to sampling rates other than those disclosed are also acceptable without departing from the scope of the invention. In the embodiment of FIG. 6, sampling rate conversion may occur in an audio file interpreter 623, and may be handled in software.

In an embodiment, the audio file is processed as described above, and then input to a voice recognition engine 620 for generation of an editable text file 624, an audio file 626, and synchronization file 630. As previously described, processing results in the generation of a read-only text file 632 and the deletion of the audio file 626, editable text file 624, and synchronization file 630. User voice model 634 and specialty specific vocabulary 636 may be used by the voice recognition engine 630 during the process of transcribing the audio file 604 into the editable text file 624.

### Another Method of Operation

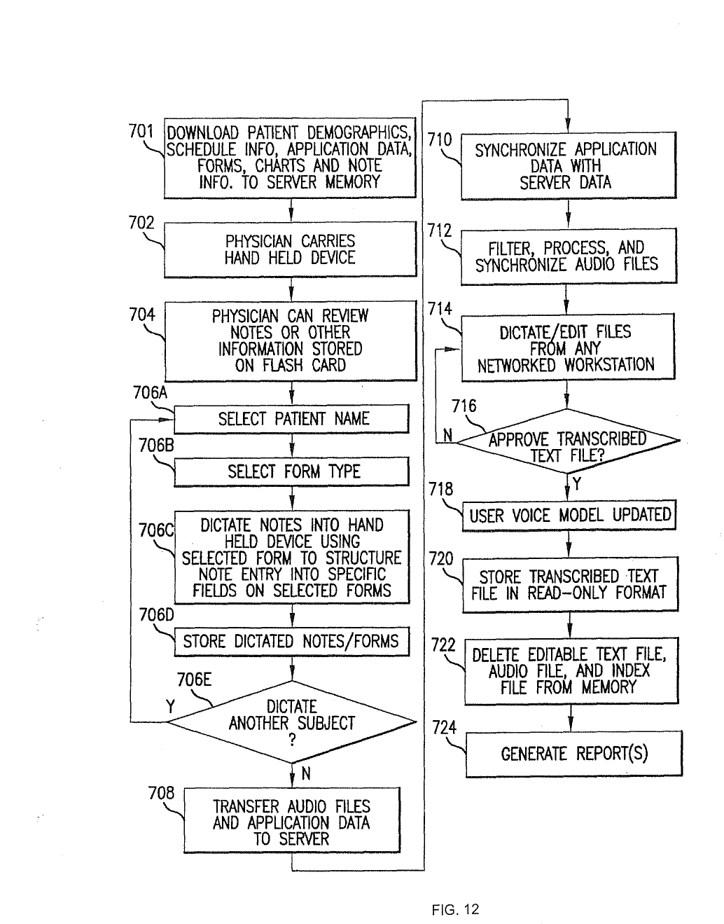

FIG. 12 is a flow diagram illustrating yet another method of operation in accordance with an embodiment of the invention. At step 701, patient demographics, schedule information, application data, forms, charts and note information may be downloaded to the handheld device from a server via a data transfer mechanism. At step 702, the physician may carry the handheld device as he performs his duties. At step 704, the physician has the ability to review previous notes related to any data stored on the handheld device.

The physician may wish to dictate a new note. At step 706 A, a patient's name may be selected by tapping on the displayed name in a list of names with a stylus on the handheld computing device screen, or by navigating the list by rotating a wheel on the side of the unit, or by other suitable means of selection. At step 706 B, a form type to be dictated is selected. At step 706 C, the physician may dictate notes into the handheld device using the selected form to structure note entry into specific fields on selected forms. Dictation may begin by depressing and releasing, or depressing and holding, the record button on the handheld computing device and thereafter beginning dictation. Macros and other voice commands can be used during dictation. Also, the user can navigate through sections, or fields, of a form by tapping on a desired section with the stylus on the handheld computing device screen, or navigate through the sections by rotating a wheel on the side of the unit, or other suitable means of selection. At step 706 D, the dictated notes or forms (for example, in the form of application data and audio files) may be stored in a memory of the handheld device. At step 706 E, the physician may repeat steps 706 A through 706 D for the same or other patients (i.e., dictation subjects).

At step 708, which may be at the day's conclusion or at any point during the day, the physician may transfer audio files and application data to a server via a data transfer mechanism. At step 710, the transferred application data is synchronized with the server's application data. At step 712, audio files are filtered, processed, and synchronized for storage and further processing or editing on the server. Further processing includes processing of the audio file in a voice recognition engine to generate transcribed text that is stored in an editable transcribed text file. An index file is also generated. The index file associates each word of text in the editable transcribed text file with the location of a sound in the audio file.

At step 714, a first user (e.g., any network user) from any networked workstation in communication with the server can add dictation to any given field in any given note or form. In an embodiment, free-form dictation for the given field may be limited to the first user, while any other authorized user (i.e., a second user) may be limited to dictating corrections to the text for that given field. The second user may, of course, enter free-form dictation into any other empty field. In addition, at step 714, any user from any networked workstation in communication with the server can edit any given field in any given note or form. Editing may involve the use of the synchronized audio file, which, as described in other embodiments herein, can be used to allow the editor to hear the recorded voice of the person that dictated the text in question. An editor may select a word or group of words for recorded audio playback. The editor may make corrections and/or alterations to the editable transcribed text file. At step 716, the transcribed text in the editable transcribed text file may be approved. If the transcribed text is not approved, then the user may return to step 714 for further dictation and/or editing of the transcribed text. If the transcribed text is approved, then at step 718 the voice models of the users that provided dictation to create the note or form are updated. At step 720, the approved transcribed text is stored in file in a read-only format. The read-only file may be signed and stored as an electronic signature. At step 722 the editable transcribed text file, audio file, and index file are deleted from the memory of the server. At step 724, reports may be generated.

The embodiments above are intended to be illustrative and not limiting. Additional embodiments are within the claims. In addition, although the present invention has been described with reference to particular embodiments, those skilled in the art will recognize that changes can be made in faun and detail without departing from the spirit and scope of the invention. Any incorporation by reference of documents above is limited such that no subject matter is incorporated that is contrary to the explicit disclosure herein.

What is claimed is:

1. A method of managing medical information comprising:
associating database elements of a database interfaced with a medical system for guiding a patient's medical care with discrete document sections of a dictated document, wherein data is automatically entered into the database elements of the database when data related to medical information is received in the discrete document sections of the dictated document.

2. The method of claim 1 wherein the type of dictated document is created by a voice command.

3. The method of claim 1 wherein the type of dictated document is created by keyboard entry.

4. The method of claim 1 wherein the discrete document sections are created by a voice command.

5. The method of claim 1 wherein the dictated document comprises a table and the discrete document sections comprise cells.

6. The method of claim 1, wherein the dictated document comprises a table and the discrete document sections comprise a cell for entering a medical value related to a mammography BI-RADS value or an oncology LI-RADS value.

7. The method of claim 1, wherein the dictated document comprises a table and the discrete document sections comprise cells for entering medical data relating to a mammography lesion chart, mammography lexicons, or an Oswestry disability survey.

8. The method of claim 1 wherein data automatically entered into the database sections of the database updates or replaces existing or stored data cross-referenced into the dictated document.

9. The method of claim 1 wherein the database is associated with a plurality of documents or modules each with discrete sections, and wherein data received into any of the discrete sections of any of the plurality of documents or modules updates, replaces, or is entered into the corresponding database sections and discrete sections of the other documents or modules.

10. The method of claim 1 wherein the discrete document sections comprises discrete fields for receiving specified type of data.

11. The method of claim 1 further comprising directing further followup with the patient based on the data placed in the database sections.

12. A method of managing medical information comprising:
receiving dictated text into a marked location within a textual representation of an existing dictation in an audio file based on subsequent dictation into a designated location within the existing dictation in the audio file, wherein the dictated text at the marked location is a textual representation of the subsequent dictation at the designated location.

11. The method of claim 10 wherein the subsequent dictation overwrites the existing dictation.

12. The method of claim 10 wherein the existing dictation is created by a first user and the dictated text is created by a second user, the second user being different from the first user.

13. The method of claim 10 wherein the marked location comprises textual instructions for re-dictation.

14. The method of claim 10 wherein the designated location comprises voice instructions for re-dictation.

15. The method of claim 10 wherein the subsequent dictation at the designated location is automatically converted into the dictated text at the marked location.

16. A system for managing medical information comprising:
a server comprising a database interfaced with a medical system for guiding a patient's medical care, wherein the database comprises database sections, and
a first computer connected to the server for receiving dictated text into a first document, wherein the first document comprises discrete document sections corresponding with the database sections of the database,
wherein data related to the dictated text received into the discrete document sections is automatically entered into the database sections.

17. The system of claim 16 wherein the first document is a table and the discrete document sections comprise cells.

18. The system of claim 16 wherein the document is a lesion table for a mammography report and the discrete document sections comprise cells for entering data relating to a lesion.

19. The system of claim 16 wherein a second document is generated based on data entered into the database sections of the database from the first document.

20. The system of claim 16 wherein data automatically entered into the database sections of the database updates or replaces existing or stored data.
